(19) United States
(12) Patent Application Publication
(10) Pub. No.: US 2010/0008502 A1
(43) Pub. Date: Jan. 14, 2010

(54) CONTENT DISTRIBUTION SYSTEM, CONTENT RECEPTION TERMINAL, CONTENT DISTRIBUTION METHOD AND PROCESSING METHOD PERFORMED WHEN VIEWING STREAMING CONTENTS

(76) Inventors: Koichi Ogasawara, Kanagawa (JP); Naohisa Kitazato, Tokyo (JP); Yasuto Masuda, Kanagawa (JP); Satoshi Kawahata, Kanagawa (JP)

Correspondence Address: FROMMER LAWRENCE & HAUG, 745 FIFTH AVENUE- 10TH FL., NEW YORK, NY, 10151, US

(21) Appl. No.: 12/496,686

(22) Filed: Jul. 2, 2009

(30) Foreign Application Priority Data
Jul. 8, 2008 (JP) P2008-177708

(51) Int. Cl. H04N 7/167

(52) U.S. Cl. 380/210

(57) ABSTRACT

There is provided a system including a plurality of content distribution servers for distributing scrambled contents and streaming-distributing an encrypted scramble key used for releasing the scrambling, a license server for providing a work key for decoding the encrypted scramble key distributed from the predetermined content distribution server, a portal server for providing address information of the predetermined content distribution server, and a content reception terminal for obtaining address information of the predetermined content distribution server from the portal server, referring to the address information to obtain the contents and the scramble key from the predetermined distribution server, decoding the scramble key by using the work key obtained from the license server and descrambling the scrambled contents by using the scramble key.

### BACKGROUND OF THE INVENTION

1. Field of the Invention

The present invention relates to a content distribution system, a content reception terminal, a content distribution method and a processing method performed when viewing streaming contents.

2. Description of the Related Art

In recent years, many music contents, video contents or the like has been treated as deterioration-less digital data and been distributed via various communication networks along with the rapid development of information processing techniques and communication techniques. The digital data is characterized in that it does not deteriorate even after repetition of copying for several times or after long distance communication.

Due to such characteristics, it happens frequently a case in which digital contents are illegally copied and illegally distributed via a broadband communication network such as Internet. In order to counter such an unauthorized fraud, for example, a technique which is referred to as Digital Rights Management (DRM) is used to limit usage or distribution of digital contents in the content streaming distribution or the like. Also a reception limit system which is referred to as Conditional Access System (CAS) is used in the terrestrial digital broadcast.

As a technique for such content distribution, there is disclosed in, for example, Japanese Patent Application Publication No. 2006-222674 a configuration of a content distribution system for dividing video contents into a plurality of content parts, encrypting and distributing each content part. Further, there is disclosed in Japanese Patent Application Publication No. 2003-150492 a technique for limiting streaming contents such that a user can view the streaming contents only for a certain time. Further, there is disclosed in Japanese Patent Application Publication No. 2005-110310 a configuration of a streaming content distribution system including a metafile management server for performing a processing of generating metafile or MIME type information.

### SUMMARY OF THE INVENTION

A related system using DRM or CAS includes, for example, a system in which a decode key for decoding contents to enable viewing thereof is directly provided to viewers who have entered into license contract. One example of the license form using the system is a Video on Demand (VoD) license form. In the VoD license form, the viewer accesses a portal server to enter into license contract, and obtains address information indicating the source of the contents. Then, when viewing, the viewer accesses a content distribution server indicated by the obtained address information to obtain the contents, and uses the provided decode key to decode the contents.

On the other hand, there is provided a system for further encrypting a scramble key for descrambling contents, and providing a work key for decoding the encryption to a license-contracted viewer. In the system, the encrypted scramble key is provided to the viewer along with the scrambled contents. A license form using such double encryption system includes, for example, a multicast (MC) license form. In the MC license form, the viewer, for example, accesses a content distribution server in which desired contents are placed from among a plurality of content distribution servers installed on a channel basis, and obtains the contents. Then, the viewer decodes the scramble key by the work key and uses the scramble key to descramble contents for enabling the viewing thereof.

In the VoD license form, since a source of contents can be designated from the portal server, the license can be advantageously managed on a content basis. However, since the contents are simply encrypted for distribution, when a content creator performs encryption, a content distributor is difficult to manage the license. Further, when the content distributor performs encryption, the content creator is difficult to manage the license. Furthermore, it is also difficult to perform encryption on a content basis when distribution of a real-time video is desired. On the other hand, in the MC license form, the MC license is employed such that the license-contacted viewer can arbitrarily view the contents provided from each content distribution server. Thus, it is difficult to realize a distribution form of providing a license to a content unit or predetermined content group. Further, it is also difficult to realize a change in connection destination on a content basis.

The present invention has been made in views of the above issues and it is desirable to provide a novel and improved content distribution system, content reception terminal, content distribution method and processing method performed when viewing streaming contents in which a content creator, distributor or the like can each manage a license and the content distributor or the like can manage the license on a content basis.

In order to solve the above issue, according to an embodiment of the present invention, there is provided a content distribution system including: a plurality of content distribution servers for distributing scrambled contents and streaming-distributing an encrypted scramble key used for releasing the scrambling; a license server for providing a work key for decoding the encrypted scramble key distributed from the predetermined content distribution server; a portal server for providing address information of the predetermined content distribution server; and a content reception terminal including an address information obtaining unit which obtains address information of the predetermined content distribution server from the portal server, a content obtaining unit which refers to the address information obtained by the address information obtaining unit and obtains the contents and the scramble key from the predetermined content distribution server, a scramble key decoding unit which decodes the scramble key by using the work key obtained from the license server, and a descramble unit which descrambles the contents by using the scramble key.

The portal server may be configured to further provide information indicating a reproduction control system of the predetermined content distribution server. Further, the content reception terminal may be configured to further include a reproduction control information obtaining unit which obtains information on a reproduction control system from the portal server and to obtain the contents and the scramble key by the content obtaining unit according to the reproduction control system indicated by the information obtained by the reproduction control information obtaining unit.

The content distribution system may further include a content distribution server for distributing encrypted contents decodable by using a content key. Further, the license server may be configured to provide the work key or the content key depending on a distribution form of contents distributed by the predetermined content distribution server. Then, the portal server may be configured to further provide information indicating a distribution form of contents distributed by the predetermined content distribution server. In this case, the content reception terminal may be configured to further include a distribution form obtaining unit which obtains information indicating a distribution form of contents distributed by the predetermined content distribution server from the portal server and a content decoding unit which decodes the encrypted contents by using the content key obtained from the license server. When an encryption form indicated by the information obtained by the distribution form obtaining unit is a content key system, the content reception terminal obtains the encrypted contents by the content obtaining unit and decodes the contents by the content decoding unit.

Further, the scramble key decoding unit included in the content reception terminal may be configured to obtain a work key from the license server when starting to receive contents in a distribution form by which contents and a scramble key are obtained by the content obtaining unit.

The content decoding unit included in the content reception terminal may be configured to obtain a content key from the license server when obtaining the encrypted contents by the content obtaining unit.

In order to solve the above issue, according to another embodiment of the present invention, there is provided a content reception terminal including: an address information obtaining unit which obtains address information of a content distribution server for streaming-distributing an encrypted scramble key used for descrambling scrambled contents or for releasing the scrambling or a content distribution server for distributing encrypted contents decodable by using a content key; a distribution form obtaining unit which obtains information indicating a distribution form of contents distributed from a content distribution server corresponding to the address information; a content obtaining unit which refers to the address information obtained by the address information obtaining unit and obtains the contents and the scramble key, or the encrypted contents from a content distribution server corresponding to the address information depending on the distribution form indicated in the information obtained by the distribution form obtaining unit; a key obtaining unit which obtains a work key for decoding the scramble key when the distribution form uses a work key system, and obtains the content key when the distribution form uses a content key system; a scramble key decoding unit which decodes the scramble key by using the work key when the distribution form uses a work key system; and a content decoding unit which descrambles contents by using the scramble key when the distribution form uses a work key system, and decodes the encrypted contents by using the content key when the distribution form is a content key system.

In order to solve the above issue, according to another embodiment of the present invention, there is provided a content distribution method including the steps of: obtaining address information of a predetermined content distribution server for distributing scrambled contents and streaming-distributing an encrypted scramble key used for releasing the scrambling from a portal server; obtaining a work key for decoding the encrypted scramble key distributed from the predetermined content distribution server from a license server; referring to the address information obtained in the address obtaining step and obtaining the contents and the scramble key from the predetermined content distribution server; decoding the scramble key by using the work key obtained in the work key obtaining step; and descrambling the scrambled contents by using the scramble key decoded in the scramble key decoding step.

In order to solve the above issue, according to another embodiment of the present invention, there is provided a processing method performed when viewing streaming contents, including the steps of: obtaining address information of a content distribution server for streaming-distributing an encrypted scramble key used for descrambling scrambled contents or for releasing the scrambling a content distribution server for distributing only encrypted contents decodable by using a content key; obtaining information indicating a distribution form of contents distributed from a content distribution server corresponding to the address information; referring to the address information obtained in the address information obtaining step and obtaining the contents and the scramble key, or the encrypted contents from a content distribution server corresponding to the address information; obtaining a work key for decoding the scramble key when the distribution form uses a work key system, and obtaining the content key when the distribution form is a content key system; decoding the scramble key by using the work key when the distribution form uses a work key system; and descrambling scrambled contents by using the scramble key when the distribution form is a work key system, and decoding the encrypted contents by using the content key when the distribution form is a content key system.

As described above, according to the present invention, a content creator or distributor can each manage a license and further the content distributor can manage a license and a source of contents on a content basis.

### BRIEF DESCRIPTION OF THE DRAWINGS

FIG. 1 is an explanatory diagram showing a configuration example of a content providing system in the VoD system;

FIG. 2 is an explanatory diagram showing a configuration example of a content providing system in the MC system;

FIG. 3 is an explanatory diagram showing one example of a system configuration of a content providing system according to one embodiment of the present invention;

FIG. 4 is an explanatory diagram showing one example of a functional configuration of a content server according to the present embodiment;

FIG. 5 is an explanatory diagram showing one example of a functional configuration of a content reception terminal according to the present embodiment;

FIG. 6A is an explanatory diagram showing a flow of a content viewing processing according to the present embodiment;

FIG. 6B is an explanatory diagram showing a flow of the content viewing processing according to the present embodiment;

FIG. 7A is an explanatory diagram showing a flow of the content viewing processing (on-contract processing) according to a variant of the present embodiment;

FIG. 7B is an explanatory diagram showing a flow of the content viewing processing (on-viewing processing) according to a variant of the present embodiment;

FIG. 8 is an explanatory diagram showing specific examples of reproduction control metafile and license information according to the present embodiment; and

FIG. 9 is an explanatory diagram showing a hardware configuration example of a terminal or server according to the present embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### [Flow of Explanation]

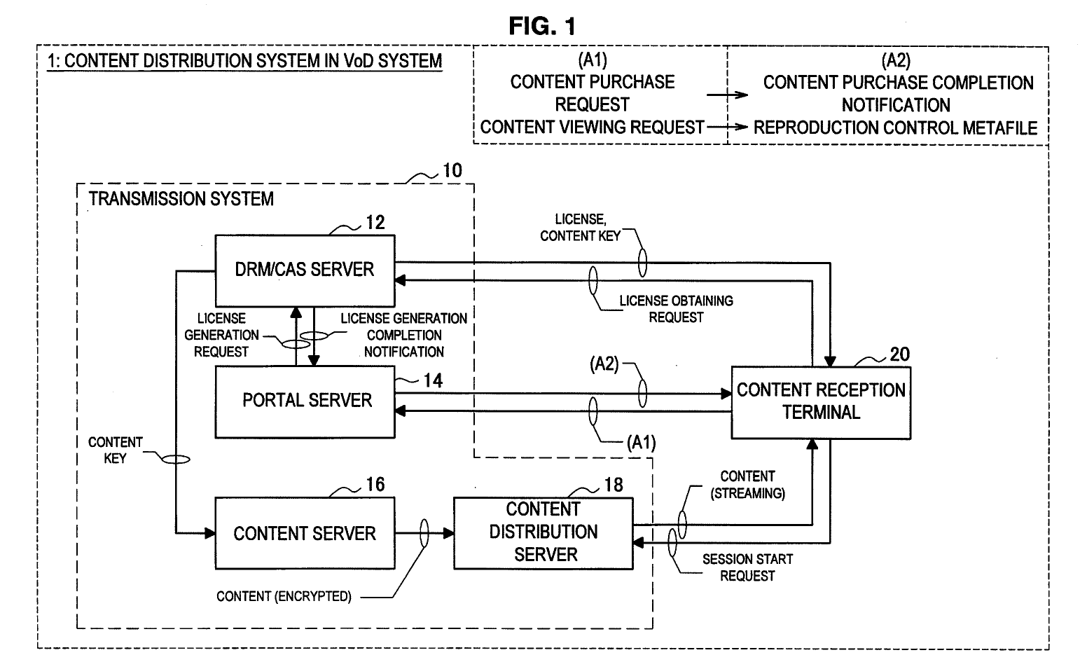

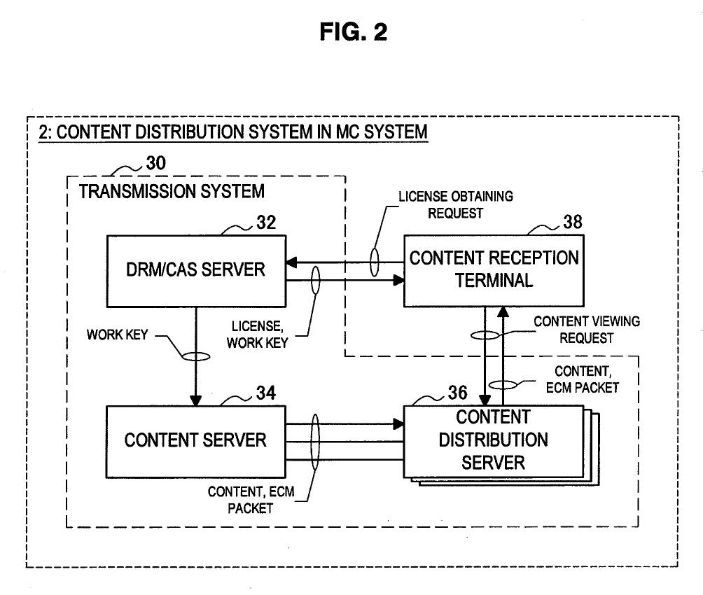

The flow of explanation on an embodiment of the present invention described below will be briefly described here. At first, a system configuration of a content distribution system related to the VoD license system will be described by giving specific examples with reference to FIG. 1. Next, a system configuration of a content distribution system related to the MC license system will be described by giving specific examples with reference to FIG. 2. What is intended by the embodiment of the present invention will be also described in the explanation on the specific examples.

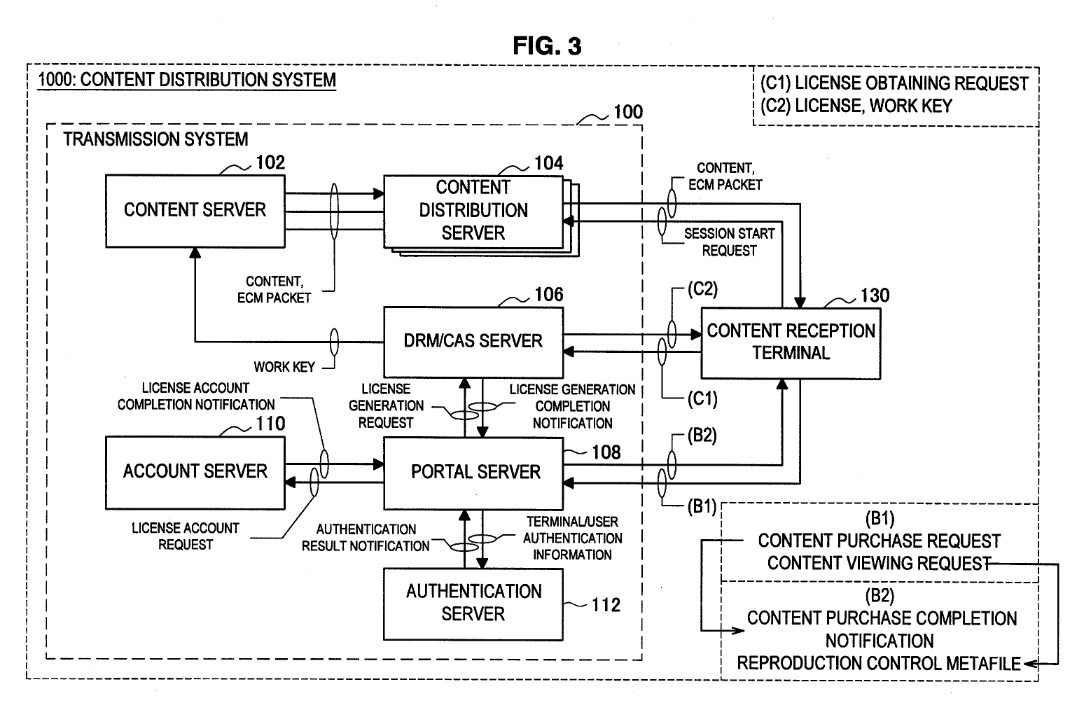

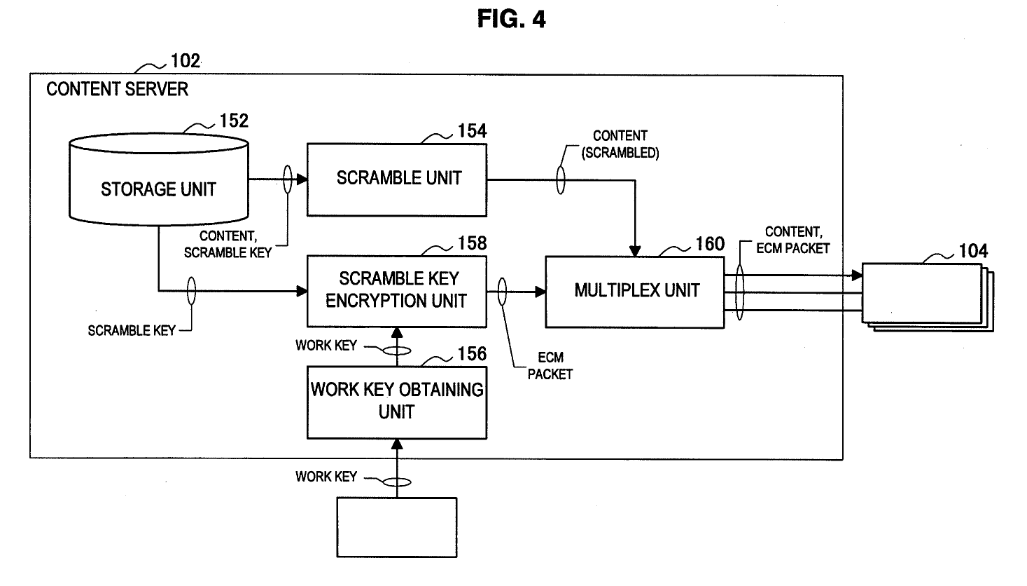

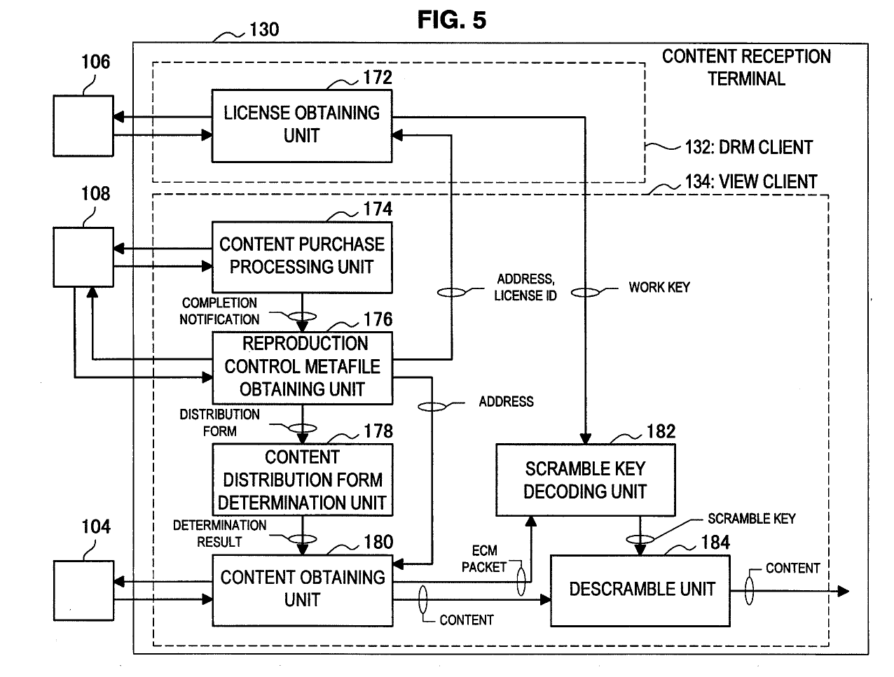

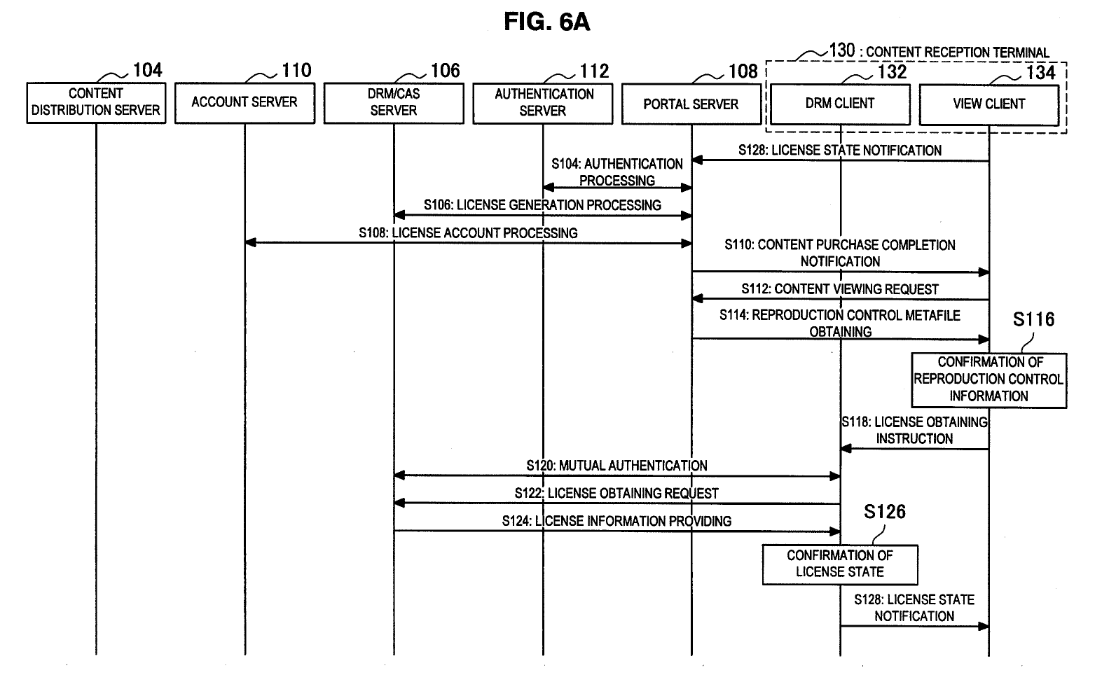

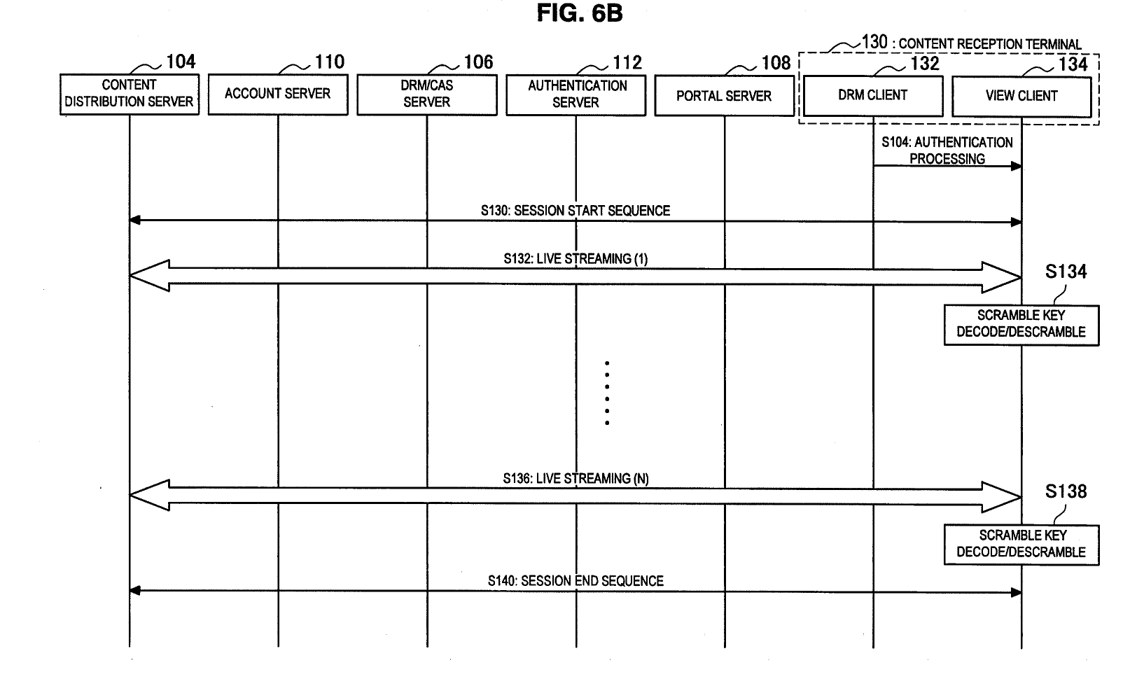

A system configuration of the content distribution system according to one embodiment of the present invention will be described below with reference to FIG. 3. A functional configuration of a content server included in the content distribution system will be described below with reference to FIG. 4. A functional configuration of a content reception terminal included in the content distribution system will be described below with reference to FIG. 5. A flow of an on-viewing content distribution processing according to the present embodiment will be described below with reference to FIGS. 6A and 6B.

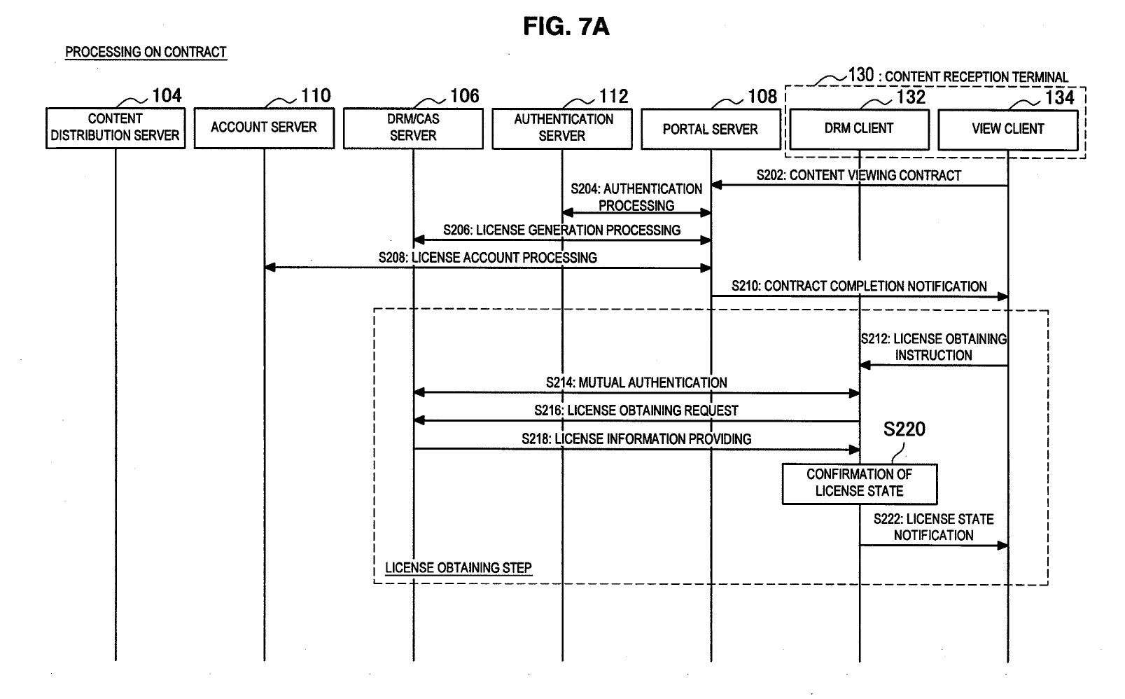

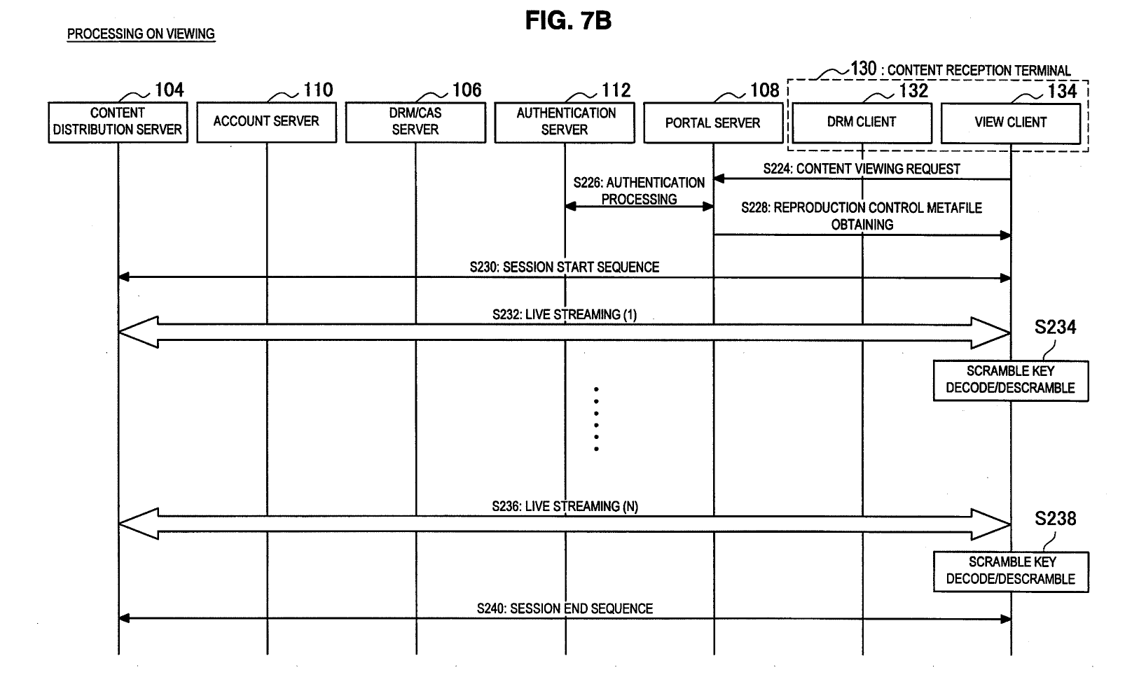

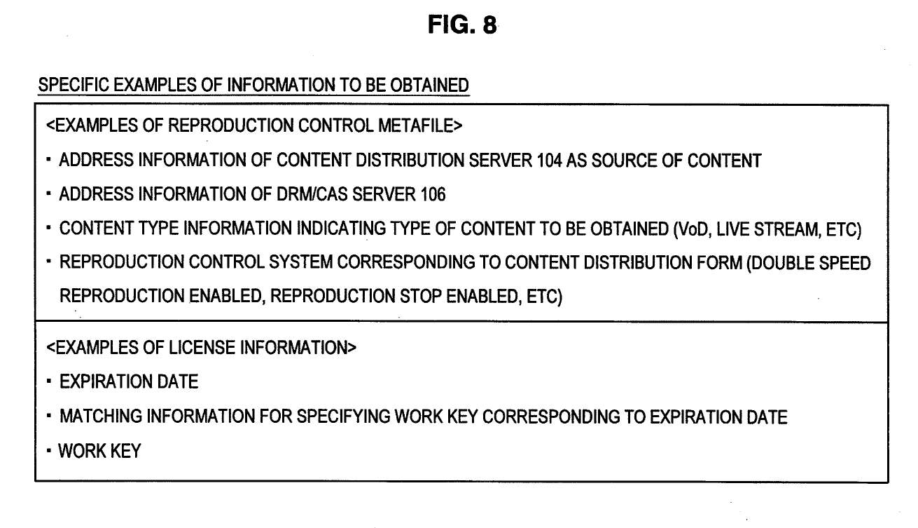

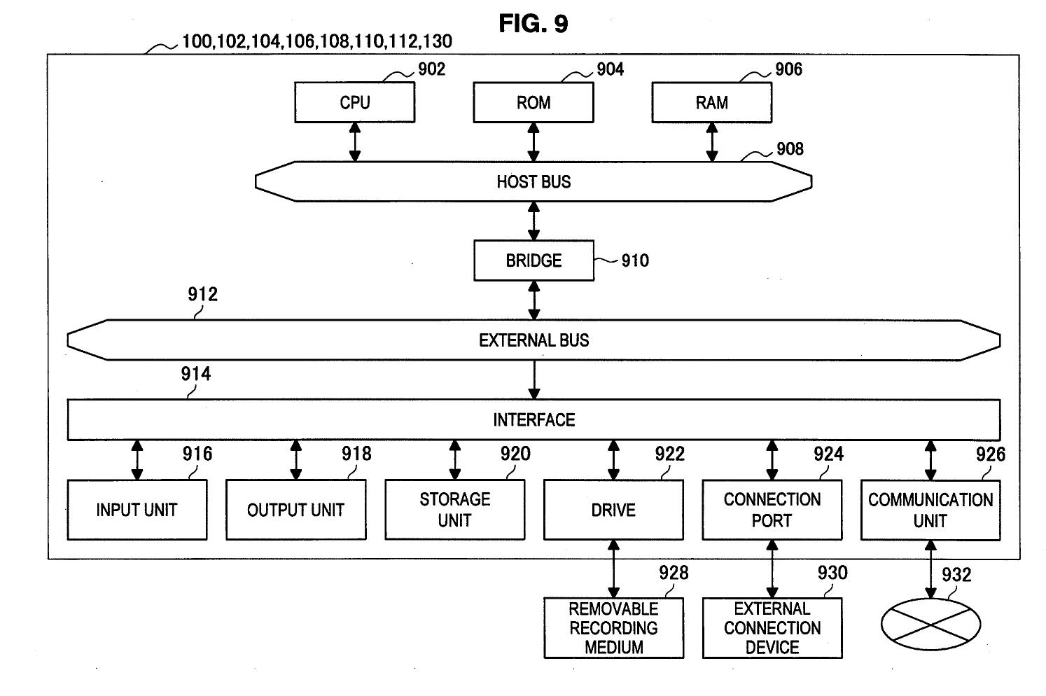

A flow of an on-contract license obtaining processing and the like according to one variant of the present embodiment will be described below with reference to FIG. 7A. Further, a flow of an on-viewing content distribution processing according to one variant of the present embodiment will be described with reference to FIG. 7B. A configuration example of a reproduction control metafile and specific examples of license information shown in FIG. 8 will be appropriately referred to in the following explanations. One example of a hardware configuration capable of realizing functions of various servers and terminals according to the present embodiment will be described below with reference to FIG. 9. Finally, operational effects made by a technical configuration according to the present embodiment will be summarized.

### [Purpose]

At first a system configuration of the content distribution system related to the VoD license system will be briefly described with reference to FIG. 1 prior to explaining the embodiment according to the present invention. Further, a system configuration of the content distribution system related to the MC license system will be briefly described with reference to FIG. 2. FIG. 1 is an explanatory diagram showing a system configuration example of a content distribution system 1 related to the VoD license system. FIG. 2 is an explanatory diagram showing a system configuration example of a content distribution system 2 related to the MC license system.

### (VoD License System)

FIG. 1 will be first referred to. As shown in FIG. 1, the content distribution system 1 mainly includes a transmission system 10 and a content reception terminal 20. The transmission system 10 mainly includes a DRM/CAS server 12, a portal server 14, a content server 16 and a content distribution server 18.

### (On-Purchase Processing)

A viewer purchases contents which he/she wishes to view prior to starting the viewing of the contents. A flow related to the content purchase processing will be briefly described. However, the flow of the processing shown herein is only an outline and actually includes various processing such as mutual authentication and the like.

For example, the viewer refers to a content list provided from the portal server 14 and designates desired contents to perform a purchase operation. At this time, a content purchase request corresponding to the contents designated by the viewer is transmitted from the content reception terminal 20 to the portal server 14. When receiving the content purchase request, the portal server 14 transmits a license generation request to the DRM/CAS server 12. When receiving the license generation request, the DRM/CAS server 12 generates a license and transmits a license generation completion notification to the portal server 14. When receiving the license generation completion notification from the DRM/CAS server 12, the portal server 14 transmits a content purchase completion notification to the content reception terminal 20.

The content purchase processing is completed through the above flow. However, actually, an authentication processing or the like is performed between the portal server 14 and the content reception terminal 20 and an account processing by an account server (not shown) connected to the portal server 14 or the like is performed.

### (Processing on Content Viewing)

Next, the viewer views the contents purchased via the above processing. A series of processing performed by the content distribution system 1 at the time of the viewing will be described. However, the flow of the processing is only an outline and actually includes various processing such as mutual authentication and the like.

When the content purchase processing is completed as described above, the viewer can access the content distribution server 18 from the content reception terminal 20 and view the purchased contents. At this time, the content reception terminal 20 performs the following processing. At first, a content viewing request is transmitted from the content reception terminal 20 to the portal server 14. When receiving the content viewing request, the portal server 14 transmits a reproduction control metafile to the content reception terminal 20.

The reproduction control metafile contains address information of the content distribution server 18 which is an obtaining source of the contents required by the content reception terminal 20 for connecting to the content distribution server 18 to establish a session therewith and address information of the DRM/CAS server 12. The reproduction control metafile may contain information on a reproduction system controllable when the contents are viewed and the like. The reproduction system described herein denotes double speed reproduction, 16-time speed reproduction, reproduction stop, fast-forwarding and the like, for example.

When receiving the reproduction control metafile, the content reception terminal 20 extracts the address information of the DRM/CAS server 12 from the reproduction control metafile, and accesses the DRM/CAS server 12 based on the address information. Then, the content reception terminal 20 transmits a license obtaining request to the DRM/CAS server 12. When receiving the license obtaining request, the DRM/CAS server 12 transmits license information and a content key to the content reception terminal 20.

The license information contains information indicating an expiration date of the content key, for example. The content key is directed for decoding the contents distributed from the content distribution server 18. However, the contents decodable by the content key are ones previously purchased by the viewer. When the content reception terminal 20 already holds the content key, only the license information corresponding to the content key may be configured to be transmitted from the DRM/CAS server 12 to the content reception terminal 20.

When receiving the license information and the content key, the content reception terminal 20 refers to the expiration date contained in the license information to confirm the expiration date of the content key. When it is confirmed that the expiration date is not expired, the content reception terminal 20 extracts the address information of the content distribution server 18, which is contained in the reproduction control metafile, required by the content reception terminal 20 for connecting to the content distribution server 18 to establish a session therewith, and accesses the content distribution server 18.

When obtaining the contents from the content distribution server 18, the content reception terminal 20 uses the content key obtained from the DRM/CAS server 12 to decode the encrypted contents. With the processing performed, the viewer can view the contents obtained by using the content reception terminal 20.

The contents distributed from the content distribution server 18 are provided by the content server 16. At this time, the content server 16 uses the content key provided from the DRM/CAS server 12 to encrypt and provide the contents to the content distribution server 18. The content key corresponds to the license of the contents purchased from the content reception terminal 20 via the portal server 14.

The configuration example of the content distribution system in the VoD license system and the flow related to the content viewing processing have been briefly described so far. As described above, in the VoD license system, the content distribution destination can be designated by the reproduction control metafile provided from the portal server 14. The contents encrypted by the individual content key are unicast-distributed to the individual content distribution server 18, thereby managing the license on a content basis. However, since the content key for decoding the encrypted contents is used to manage the license, there is an issue in which the content creator or distributor is difficult to manage the license in mutually different forms. When one wishes to streaming-distribute real-time videos, the contents may not be encrypted.

### (MC License System)

FIG. 2 will be referred to below. As shown in FIG. 2, the content distribution system 2 mainly includes a transmission system 30 and a content reception terminal 38. The transmission system 30 mainly includes a DRM/CAS server 32, a content server 34 and a content distribution server 36.

### (On-Contract Processing)

The viewer makes a content viewing contract prior to starting to view contents. Thus, a flow related to the view contract making processing will be briefly described below. However, the flow of the processing shown herein is only an outline and actually includes various processing such as mutual authentication and the like.

For example, the viewer previously makes a content viewing contract by the month. In many cases, the viewer does not make a view contract with individual contents but makes a contract by which he/she can freely view the contents corresponding to predetermined channels. Also the contract by which one can freely select and view several channels is made in many cases. Though the contract contents are freely set between the content distributor and the viewer, a case in which the above contract is made will be described by way of example.

In this case, the viewer uses the content reception terminal 38 to access the DRM/CAS server 32 and is given the license. At this time, the content reception terminal 38 transmits a license obtaining request to the DRM/CAS server 32. When receiving the license obtaining request, the DRM/CAS server 32 performs predetermined authentication processing, account processing or the like. When these processing are completed, the DRM/CAS server 32 transmits license information and a work key to the content reception terminal 38. The license information contains information indicating an expiration date of the work key and information indicating a correspondence relationship between the expiration date and the work key. The work key denoted herein is directed for decrypting the scramble key used for descrambling the contents.

The content viewing contract is made through the above flow. As described above, the content reception terminal 38 is in a state where the work key corresponding to the license is held. In the MC license system, however, it is supposed that the content reception terminal 38 recognizes the address information of the DRM/CAS server 32 and the address information of the content distribution server 36 for distributing contents. Thus, it is noted that the reproduction control metafile or portal server used in the VoD license system is not present.

### (Processing on Content Viewing)

Next, the viewer views the contents based on the made contract. A series of processing performed by the content distribution system 2 on viewing will be described. However, the flow of the processing denoted herein is only an outline and actually includes various processing such as mutual authentication and the like.

When the contact is previously made as described above, the viewer can access the content distribution server 36 which is distributing desired contents from the content reception terminal 38, and view the distributed contents. At this time, the content reception terminal 38 transmits a content viewing request to the content distribution server 36 which is distributing the contents designated by the viewer. When receiving the content viewing request, the content distribution server 36 transmits the contents and an Entitle Control Message (ECM) packet to the content reception terminal 38.

The contents transmitted at this time are scrambled by the content server 34 described later. The ECM packet denoted herein is obtained by using the work key to encrypt the scramble key for descrambling the contents.

When receiving the contents and the ECM packet, the content reception terminal 38 uses the previously obtained work key to decode the scramble key from the ECM packet. Further, the content reception terminal 38 uses the decoded scramble key to descramble the contents. The above processing is performed so that the viewer can view the contents obtained by using the content reception terminal 38.

The contents distributed from the content distribution server 36 are scrambled by the content server 34 as described above. The content server 34 obtains a work key from the DRM/CAS server 32 and uses the work key to encrypt the scramble key. Then, the scramble key encrypted by the content server 34 is transmitted as the ECM packet to the content distribution server 36. However, the content server 34 uses the same work key to encrypt the scramble key of each content transmitted to the several content distribution servers 36. Thus, the viewer can select an arbitrary content distribution server 36 and view the contents.

The configuration example of the content distribution system in the MC license system and the flow related to the content viewing processing have been briefly described above. As described above, in the MC license system, since two types of encryption processing such as the content scrambling and the scramble key encryption are performed, the content creator and distributor can individually manage the license. For example, the content creator manages a providing destination of the scramble key, thereby realizing the license management for the content distributor. On the other hand, the content distributor manages a providing destination of the work key, thereby realizing the license management for the content viewer. However, in order to realize the multicast distribution, the scramble keys of different contents distributed to the same multicast address are encrypted by the same work key, which was an issue in which the license management for each content was difficult. Further, it could not realize a distribution form in which different sources of contents on a content basis were provided to the viewer for the contents provided in a streaming manner.

The embodiment according to the present invention described below solves the issues in the VoD license system and MC license system, and intends to propose a content distribution system having advantages of both the systems.

### Embodiment

One embodiment according to the present invention will be described below. The present embodiment relates to a content distribution system which employs a license form using two types of encryption processing similarly to the MC license system and enables the license management on a content basis.

### [Configuration of Content Distribution System 1000]

A system configuration of a content distribution system 1000 according to the present embodiment and a flow of a content distribution processing according to the present embodiment will be described first with reference to FIG. 3. FIG. 3 is an explanatory diagram showing a system configuration example of the content distribution system 1000 according to the present embodiment.

As shown in FIG. 3, the content distribution system 1000 mainly includes a transmission system 100 and a content reception terminal 130. Further, the transmission system 100 mainly includes a content server 102, a content distribution server 104, a DRM/CAS server 106, a portal server 108, an account server 110 and an authentication server 112. However the account server 110 and the authentication server 112 may be appropriately omitted depending on a form of the embodiment.

### (On-Purchase Processing)

Also in the present embodiment, the viewer purchases contents which he/she wishes to view prior to starting the viewing of the contents. Thus, a flow related to the content purchase processing will be described.

At first, the viewer refers to a content list provided from the portal server 108 and designates desired contents to perform a purchase operation. The content list is presented in a program table form such as Electronic Program Guide (EPG) or the like. In this case, the viewer designates a desired program from the program table, thereby being able to purchase the contents corresponding to the program. Of course, the presentation form of the content list is arbitrary. When such a purchase operation is performed, the content purchase processing is carried on by the content reception terminal 130.

When the above purchase operation is performed, the content reception terminal 130 transmits a content purchase request to the portal server 108. At this time, the content reception terminal 130 transmits authentication information for specifying the viewer and the terminal to the portal server 108. When receiving the content purchase request and the authentication information, the portal server 108 transmits the received authentication information to the authentication server 112. The authentication server 112 uses the received authentication information to perform a processing of authenticating the viewer and the terminal, and notifies the portal server 108 of the authentication result.

When the portal server 108 receives the notification of the authentication result from the authentication server 112 and confirms that the authentication has been successfully completed, the portal server 108 transmits a license generation request to the DRM/CAS server 106. When receiving the license generation request, the DRM/CAS server 106 generates a license and transmits a license generation completion notification to the portal server 108. The portal server 108 receives the license generation completion notification from the DRM/CAS server 106 and transmits a license account request to the account server 110.

The account server 110 performs an account processing for the license based on the license account request received from the portal server 108. When the account processing is completed, the account server 110 transmits a license account completion notification to the portal server 108. When receiving the license account completion notification, the portal server 108 transmits a content purchase completion notification to the content reception terminal 130. When receiving the content purchase completion notification, the content reception terminal 130 completes the content purchase processing.

The on-purchase processing has been described above. However various modifications can be made for the content purchase processing. For example, the account processing or the like by the account server 110 is omitted for unaccounted contents. Similarly, the authentication processing or the like can be omitted depending on a form of the embodiment as well. Further, various modifications can be made also in the presentation form of the content list or the like provided from the portal server 108 to the content reception terminal 130.

### (Processing on Content Viewing)

Next, the viewer views the contents purchased through the above processing. A series of processing performed by the content distribution system 1000 on viewing will be described. The flow of the processing denoted herein is only an outline and actually contains various processing such as mutual authentication.

When the content purchase processing is completed as described above, the viewer can access the content distribution server 104 from the content reception terminal 130 and view the purchased contents. At this time, the following processing is performed by the content reception terminal 130. At first, a content viewing request is transmitted from the content reception terminal 130 to the portal server 108. When receiving the content viewing request, the portal server 108 transmits a reproduction control metafile to the content reception terminal 130.

The reproduction control metafile contains address information of the content distribution server 104 which is an obtaining source of the contents required by the content reception terminal 130 for connecting to the content distribution server 104 to establish a session therewith, and address information of the DRM/CAS server 106.

The reproduction control metafile contains information on a reproduction system controllable when viewing the contents and the like. The reproduction system described herein denotes double speed reproduction, 16-time speed reproduction, reproduction stop, fast forwarding and the like, for example. Further, the reproduction control metafile contains content type information indicating a type of contents to be obtained. The content type information indicates, for example, whether the contents are distributed in the VoD license form, whether the contents are distributed in the MC license form such as live streaming form or the like.

The content reception terminal 130 extracts the address information of the DRM/CAS server 106 from the above reproduction control metafile and accesses the DRM/CAS server 106 based on the address information. Then, the content reception terminal 130 transmits a license obtaining request to the DRM/CAS server 106. When receiving the license obtaining request, the DRM/CAS server 106 transmits license information and a work key to the content reception terminal 130.

The license information contains information indicating an expiration date of the content key, for example. The work key is directed for decoding the scramble key of the contents distributed from the content distribution server 104 similarly to the MC license system. However the scramble key decodable by the work key corresponds to the contents previously purchased by the viewer. When a view contract of the contents distributed from the several content distribution servers 104 is made by the viewer, the work key common to the content distribution servers 104 is provided to the content reception terminal 130.

When the license information and the work key are transmitted as described above, the content reception terminal 130 receives the same and refers to the expiration date contained in the license information to confirm the expiration date of the work key. When confirming that the expiration date is not expired, the content reception terminal 130 extracts the address information of the content distribution server 104 contained in the reproduction control metafile, and accesses the content distribution server 104 corresponding to the address information, thereby obtaining the scrambled contents and the ECM packet.

When the purchase processing or contract processing has been completed for the contents distributed from the plurality of content distribution servers 104, the reproduction control metafile contains the address information of the plurality of content distribution servers 104. In this case, the content reception terminal 130 can select the content distribution server 104 which is distributing desired contents, and can obtain the contents from the selected content distribution server 104. For example, the viewer can purchase only the contents distributed from three channels. In this case, the reproduction control metafile contains the address information of the content distribution server 104 corresponding to the three channels and the like.

When obtaining the scrambled contents and the ECM packet from the content distribution server 104, the content reception terminal 130 uses the work key obtained from the DRM/CAS server 106 to decode the scramble key from the ECM packet. Further, the content reception terminal 130 uses the decoded scramble key to descramble the contents. With the above processing, the viewer can view the contents obtained by using the content reception terminal 130.

The contents and the ECM packet distributed from the content distribution server 104 are provided by the content server 102. The content server 102 scrambles the contents and uses the work key provided from the DRM/CAS server 106 to encrypt the scramble key for descrambling, thereby generating the ECM packet. Then, the content server 102 provides the scrambled contents and the ECM packet to the content distribution server 104.

However, when a license is given to the plurality of contents distributed from the content distribution servers 104, the content server 102 encrypts the scramble key of the contents by the common work key. With such configuration, each content is scrambled by a different scramble key on a content basis. On the other hand, a group of contents to be distributed is restricted by the same work key from being viewed. In other words, the group of contents is configured to enable the license management of the individual contents while being the multicast license.

The configuration example of the content distribution system 1000 according to the present embodiment and the flow of the content viewing processing have been described above. As described above, since two types of encryption processing such as content scrambling and scramble key encryption are performed in the content distribution system according to the present embodiment, the license can be individually managed between the content creator and distributor. Further, the limitation of the source of contents by the reproduction control metafile or the license management using the work key enables the distribution form to be freely set at multicast or unicast.

### [Functional Configuration of Content Server 102]

A functional configuration of the content server 102 included in the content distribution system 1000 will be described herein with reference to FIG. 4. FIG. 4 is an explanatory diagram showing one example of the functional configuration of the content server 102 according to the present embodiment.

As shown in FIG. 4, the content server 102 mainly includes a storage unit 152, a scramble unit 154, a work key obtaining unit 156, a scramble key encryption unit 158 and a multiplex unit 160.

The function of the storage unit 152 is realized by, for example, a RAM 906, a storage unit 920, a removable recording medium 928 or the like in the hardware configuration described later. The functions of the scramble unit 154 and the scramble key encryption unit 158 are realized by a CPU 902 based on programs recorded in, for example, a ROM 904, the RAM 906, the storage unit 920 or the removable recording medium 928. Further, the functions of the work key obtaining unit 156 and the multiplex unit 160 are realized by, for example, a connection port 924 or a communication unit 926.

### (Storage Unit 152)

The storage unit 152 stores therein the contents distributed by the content distribution server 104. However the contents are not scrambled. Also, the storage unit 152 stores therein a scramble key for scrambling the contents. Further, the storage unit 152 stores therein a scramble key for descrambling the scrambled contents. However the scramble key used for descrambling may be the same as or different from the scramble key used for scrambling. In the following description, however, the description will be made assuming the scramble keys as the same.

### (Scramble Unit 154)

The scramble unit 154 obtains contents and a scramble key from the storage unit 152. The scramble unit 154 uses the obtained scramble key to scramble the contents. At this time, the contents to be scrambled and the scramble key correspond to each other. Then, which contents are scrambled by which scramble key is set by the content creator, for example. The contents scrambled by the scramble unit 154 are input into the multiplex unit 160.

### (Work Key Obtaining Unit 156, Scramble Key Encryption Unit 158)

The work key obtaining unit 156 obtains a work key from the DRM/CAS server 106. At this time, the work key obtaining unit 156 also obtains information indicating a correspondence relationship between the obtained work key and the contents (or scramble key). Then, the work key obtaining unit 156 inputs the obtained work key and the information indicating the correspondence relationship into the scramble key encryption unit 158.

The scramble key encryption unit 158 obtains a scramble key from the storage unit 152. Further, the scramble key encryption unit 158 obtains a work key and information indicating a correspondence relationship from the work key obtaining unit 156. Then, the scramble key encryption unit 158 uses the work key corresponding to the obtained scramble key to encrypt the scramble key based on the information indicating the correspondence relationship input from the work key obtaining unit 156. The scramble key encrypted by the scramble key encryption unit 158 is input as the ECM packet into the multiplex unit 160.

### (Multiplex Unit 160)

As described above, the multiplex unit 160 is input with the scrambled contents from the scramble unit 154 and with the ECM packet from the scramble key encryption unit 158. However the contents and the ECM packet input into the multiplex unit 160 are assumed to correspond to each other. In other words, the scramble key used for scrambling the input contents is assumed to be the same as the encrypted scramble key constituting the ECM packet. In this case, the multiplex unit 160 transmits the input contents and ECM packet as a set to the content distribution server 104.

As previously described, a plurality of scramble keys may be encrypted by the same work key depending on the contents of the license contract. In such a case, the multiplex unit 160 makes each content and ECM packet as a set to be transmitted to each content distribution server 104. On the contrary, there may be employed a form in which a license is issued to an individual content. In this case, the scramble key corresponding to the individual content is encrypted by an individual work key and transmitted to the respective corresponding content distribution server 104.

The functional configuration of the content server 102 according to the present embodiment has been described above. As described above, the content encryption processing according to the present embodiment is realized by the content scramble processing using a scramble key and the encryption processing of encrypting the scramble key by the work key. Thus, the scramble key is used to enable the license management on a content basis and the work key is used to enable the license management in units of combination of the distributed contents. In other words, the MC license form is realized.

### [Functional Configuration of Content Reception Terminal 130]

A functional configuration of the content reception terminal 130 included in the content distribution system 1000 will be descried below with reference to FIG. 5. FIG. 5 is an explanatory diagram showing one example of the functional configuration of the content distribution terminal 130 according to the present embodiment.

As shown in FIG. 5, the content reception terminal 130 mainly includes a DRM client 132 and a view client 134. The DRM client 132 is a means for accessing the DRM/CAS server 106 and includes a license obtaining unit 172. The view client 134 is a means for performing a processing on content viewing. The view client 134 includes a content purchase processing unit 174, a reproduction control metafile obtaining unit 176, a content distribution form determination unit 178, a content obtaining unit 180, a scramble key decoding unit 182 and a descramble unit 184.

The primary functions of the DRM client 132 and the view client 134 are realized by the CPU 902 based on the programs recorded in, for example, the ROM 904, the RAM 906, the storage unit 920, the removable recording medium 928 or the like in the hardware configuration described later. However the primary functions of the license obtaining unit 172, the reproduction control metafile obtaining unit 176 and the content obtaining unit 180 are realized by, for example, the connection port 924 or the communication unit 926.

A functional configuration related to the content purchase processing will be described first. Then, a functional configuration related to the content viewing processing will be described.

### (Content Purchase Processing Unit 174)

The content purchase processing unit 174 transmits a content purchase request to the portal server 108. Further, the content purchase processing unit 174 receives a content purchase completion notification transmitted from the portal server 108 in response to the content purchase request. When receiving the content purchase completion notification, the content purchase processing unit 174 notifies the reproduction control metafile obtaining unit 176 of the fact that the content purchase has been completed.

### (Reproduction Control Metafile Obtaining Unit 176)

After receiving the notification indicating that the content purchase has been completed from the content purchase processing unit 174, the reproduction control metafile obtaining unit 176 transmits a content viewing request to the portal server 108. Further, the reproduction control metafile obtaining unit 176 receives a reproduction control metafile transmitted from the portal server 108 in response to the content viewing request. The reproduction control metafile contains the address information of the content distribution server 104, the address information of the DRM/CAS server 106, content type information, distribution form information and the like as shown in FIG. 8.

The reproduction control metafile obtaining unit 176 extracts and inputs the address information of the DRM/CAS server 106 and the like from the received reproduction control metafile into the license obtaining unit 172. Also reproduction control metafile obtaining unit 176 extracts and inputs the address information of the content distribution server 104 from the reproduction control metafile into the content obtaining unit 180. Further, the reproduction control metafile obtaining unit 176 extracts and inputs the information on the content distribution form from the reproduction control metafile into the content distribution form determination unit 178.

### (Content Distribution Form Determination Unit 178)

The content distribution form determination unit 178 determines a content distribution form based on the information input from the reproduction control metafile obtaining unit 176. The information on the content distribution form includes, for example, information indicating a type of contents or information on the reproduction control system capable of being employed for the contents. A determination is made as to whether the content type is, for example, contents distributed in the VoD system, contents distributed in the live streaming system, other contents or the like. Also a determination is made as to whether the reproduction control system is, for example, capable of double speed reproduction, reproduction stop or the like. The result determined by the content distribution form determination unit 178 is input into the content obtaining unit 180.

### (Content Obtaining Unit 180)

The content obtaining unit 180 uses the address information of the content distribution server 104 input from the reproduction control metafile obtaining unit 176 or the like to access the content distribution server 104. Then, the content obtaining unit 180 transmits a session start request to the content distribution server 104. Thereafter, the content obtaining unit 180 receives the contents and the ECM packet transmitted from the content distribution server 104 in response to the session start request. However the contents are scrambled. The contents received by the content obtaining unit 180 are input into the descramble unit 184. Further, the ECM packet received by the content obtaining unit 180 is input into the scramble key decoding unit 182.

A processing of the content obtaining unit 180 related to the determination result on the content distribution form will be briefly described herein. The determination result on the distribution form is processed as the following (A) or (B), for example.

(A) In the above description, it is assumed that the contents and the ECM packet in the MC license system are distributed from all the content distribution servers 104. However, a system configuration may be considered in which the content distribution servers 104 may transmit the contents encrypted by the content key as in the VoD license system. In this case, the content reception terminal 130 needs to know which is decoded by using the key (work key, content key) obtained from the DRM/CAS server 106.

In such a case, when the determination result input by the content distribution form determination unit 178 is the content key encryption system, the content obtaining unit 180 inputs the determination result into the scramble key decoding unit 182 and the descramble unit 184. On the contrary, in the case of the double encryption processing system using a work key, which is the original processing form, the determination result is not input into the scramble key decoding unit 182 and the descramble unit 184. However the determination result may be configured to be input into the scramble key decoding unit 182 and the descramble unit 184.

(B) When viewing the streaming contents, the content reception terminal 130 preferably knows to which reproduction control system the contents or the content distribution server 104 corresponds. For example, this is because even when reproduction control information for designating double speed reproduction is transmitted to the content distribution server 104 not adapted to the double speed reproduction, the content obtaining unit 180 may not correctly obtain and reproduce the contents. Therefore, the content obtaining unit 180 obtains the contents from the content distribution server 104 in a distribution form compatible with the determination result of the content distribution form determination unit 178.

### (License Obtaining Unit 172)

The license obtaining unit 172 uses the address information input from the reproduction control metafile obtaining unit 176 to access the DRM/CAS server 106. At this time, the license obtaining unit 172 uses the authentication information on a previously-held device specific ID and the like to perform the mutual authentication with the DRM/CAS server 106. Then, the license obtaining unit 172 transmits a license obtaining request to the DRM/CAS server 106. Thereafter, the license obtaining unit 172 receives the license information and the work key transmitted from the DRM/CAS server 106 in response to the license obtaining request.

The license information includes a work key, an expiration date of the work key, and information indicating a correspondence relationship between the expiration date and the work key as shown in FIG. 8. The work key may be configured to be previously obtained and held without being obtained at this timing. When the license information and the work key are obtained in this manner, the license obtaining unit 172 refers to the expiration date contained in the license information and determines whether the work key is valid. When the work key is valid, the license obtaining unit 172 inputs the work key into the scramble key decoding unit 182.

### (Scramble Key Decoding Unit 182)

The scramble key decoding unit 182 uses the work key input by the license obtaining unit 172 to decode the scramble key from the ECM packet input by the content obtaining unit 180. The scramble key decoded by the scramble key decoding unit 182 is input into the descramble unit 184. However when the determination result indicating that the distribution form is the content key encryption system is input from the content obtaining unit 180, the key input from the license obtaining unit 172 is input into the descramble unit 184 as it is.

### (Descramble Unit 184)

The descramble unit 184 uses the scramble key decoded by the scramble key decoding unit 182 to descramble the contents input from the content obtaining unit 180. However when the determination result indicating that the distribution form is the content key encryption system is input from the content obtaining unit 180, the descramble unit 184 uses the key input from the scramble key decoding unit 182 to decode the contents obtained by the content obtaining unit 180. With the processing, the contents are recovered into a viewable state.

The functional configuration of the content reception terminal 130 according to the present embodiment has been described above. With the above configuration, in the configuration of using the reproduction control metafile to designate the source of contents as in the VoD license system, the double encryption system like the MC license can be applied.

### (Content Distribution Form)

How to cope with information on a content distribution form contained in the reproduction control metafile will be supplementarily described. As described above, the reproduction control metafile contains information on the reproduction control system and information on the license form as the information indicating the content distribution form. When the content obtaining unit 180 obtains contents, the information on the reproduction control system is used to obtain the contents in a form to which the content distribution server 104 corresponds. On the other hand, the information on the license form also depends on the system configuration and the explanation thereof will be omitted here.

As described above, the content distribution system 1000 according to the present embodiment employs the double encryption system using a work key similarly to the MC license system. However, the content reception terminal 130 according to the present embodiment can cope with a system form extended by adding system elements in the VoD license system to the content distribution system 1000. Actually, a technique according to the present embodiment may be applied and extended to the existing VoD license system or the like. Of course, the thus extended system falls within a technical scope of the present embodiment.

However, when carrying out the extension, the content reception terminal 130 needs to recognize whether the contents are distributed in the MC license system or the VoD license system. Of course, other license systems are similarly treated. The content distribution system 1000 adds the information on the content distribution form to the reproduction control metafile to be transmitted from the portal server 108. The content reception terminal 130 recognizes the content distribution form and switches the content decode processing.

For example, when it is determined that the distribution form is the VoD license system, the content reception terminal 130 obtains the content key from the DRM/CAS server 106 by the license obtaining unit 172. Further, the content obtaining unit 180 obtains only the encrypted contents from the content distribution server 104. Further, the scramble key decoding unit 182 does not function and the descramble unit 184 uses the content key to decode the contents.

As described above, the information indicating the content distribution form is contained in the reproduction control metafile so that the processing on content viewing can be easily switched. Consequently, it is possible to secure the compatibility with other license system and to realize the technique according to the present embodiment based on the existing system configuration. Consequently, the technique proposed in the present embodiment can be realized at relatively low development cost and introduction cost.

### [On-Viewing Processing Sequence]

An on-viewing processing sequence in the content distribution system 1000 according to the present embodiment will be described below with reference to FIGS. 6A and 6B. Here, a flow of the processing performed in the entire system will be described instead of considering the detailed functional configuration of the content server 102 or the content reception terminal 130.

FIG. 6A is referred to at first. As shown in FIG. 6A, a content purchase request is first transmitted from the view client 134 to the portal server 108 (S102). Next, an authentication processing is performed between the portal server 108 and the authentication server 112 (S104). Then, a license generation processing is performed between the portal server 108 and the DRM/CAS server 106 (S106). Then, an account processing is performed between the portal server 108 and the account server 110 (S108). Next, a content purchase completion notification is transmitted from the portal server 108 to the view client 134 (S110). With the above processing, a series of processing related to the content purchase is completed.

Next, a content viewing request is transmitted from the view client 134 to the portal server 108 (S112). Next, a reproduction control metafile is transmitted from the portal server 108 to the view client 134 (S114). Next, reproduction control information contained in the reproduction control metafile is confirmed by the view client 134 (S116). At this stage, address information of each server and the like is extracted from the reproduction control metafile. Then, a license obtaining instruction is issued from the view client 134 to the DRM client 132 (S118).

Then, mutual authentication is performed between the DRM client 132 and the DRM/CAS server 106 (S120). Then, a license obtaining request is transmitted from the DRM client 132 to the DRM/CAS server 106 (S122). Then, license information is provided from the DRM/CAS server 106 to the DRM client 132 (S124). For example, a work key is transmitted together with the license information at this stage. Next, the license state is confirmed by the DRM client 132 (S126). In other words, the expiration date of the work key is confirmed. Then, the license state is notified from the DRM client 132 to the view client 134 (S128).

FIG. 6B is referred to. Then, a session is started between the view client 134 and the content distribution server 104 (S130). Then, live streaming is performed between the view client 134 and the content distribution server 104 (S132). At this time, the scrambled contents and the ECM packet are transmitted from the content distribution server 104 to the view client 134. The view client 134 uses the work key to decode the scramble key and uses the scramble key to descramble the contents (S134). Similarly, the live streaming is repeated (S136) and the decode of the scramble key and the descramble of the contents are repeated each time (S138). When the viewing is terminated, a session end processing is performed between the view client 134 and the content distribution server 104 (S140) so that the on-viewing processing is terminated.

### (Variant: When View Contract is Made)

One variant related to the content distribution system according to the present embodiment will be described below with reference to FIGS. 7A and 7B. The present variant is configured such that a viewer makes a view contract for certain contents and uses a license provided at the contract making to view the contents. Like the variant, various modifications are possible for the view contract or content purchase form. Even if such a modification is made, a technical spirit of the present embodiment in the on-viewing processing sequence is contained in the modification, the modification falls within the technical scope of the present embodiment.

FIG. 7A is referred to first. As shown in FIG. 7A, at first, the view client 134 transmits a content viewing contract request to the portal server 108 (S202). Then, the portal server 108 performs the authentication processing with respect to the authentication server 112 (S204). Then, a license generation processing is performed between the portal server 108 and the DRM/CAS server 106 (S206). Then, a license account processing is performed between the portal server 108 and the account server 110 (S208). Then, a contract completion notification is transmitted from the portal server 108 to the view client 134 (S210). In this manner, even when the view contract is made, the flow of the processing so far is substantially identical to that of the purchase processing.

Next, the view client 134 transmits a license obtaining instruction to the DRM client 132 (S212). Then, mutual authentication is performed between the DRM client 132 and the DRM/CAS server 106 (S214). Then, a license obtaining request is transmitted from the DRM client 132 to the DRM/CAS server 106 (S216). Then, license information is provided from the DRM/CAS server 106 to the DRM client 132 (S218). For example, a work key is provided together with the license information at this stage. Then, a license state is confirmed by the DRM client 132 (S220). Then, the license state is notified from the DRM client 132 to the view client 134 (S222).

A series of processing from step S212 to step S222 is called a license obtaining step SL. A license is provided to the contractor by the license obtaining step SL until the expiration date contained in the license information. Up to the sequence shown in FIG. 7A corresponds to the on-contract processing. Next, the on-viewing processing sequence will be described.

FIG. 7B is referred to. As shown in FIG. 7B, at first, the view client 134 transmits a content viewing request to the portal server 108 (S224). Then, an authentication processing is performed between the portal server 108 and the authentication server 112 (S226). Then, a reproduction control metafile is transmitted from the portal server 108 to the view client 134 (S228). Then, live streaming is performed between the view client 134 and the content distribution server 104 (S232). At this time, the scrambled contents and the ECM packet are transmitted from the content distribution server 104 to the view client 134.

The view client 134 uses the work key to decode the scramble key and uses the scramble key to descramble the contents (S234). Similarly, the live streaming is repeated (S236) and the decode of the scramble key and the descramble of the contents are repeated each time (S238). When the viewing is terminated, a session end processing is performed between the view client 134 and the content distribution server 104 (S240) and the on-viewing processing is terminated. When the contract period is expired, the viewer performs the processing of the license obtaining step SL shown in FIG. 7A again to perform a license update processing.

A flow of the content distribution processing according to one variant of the present embodiment has been described above. In this manner, the technique of the present embodiment can be applied even when the view contract is made.

### [Hardware Configuration]

A function of each constituent included in the apparatus can be realized by an information processing apparatus having a hardware configuration shown in FIG. 9 and by using computer programs for realizing the above function. FIG. 9 is an explanatory diagram showing a hardware configuration of an information processing apparatus capable of realizing a function of each constituent in the above apparatus. A form of the information processing apparatus is arbitrary and includes, for example, forms of portable information terminal such as personal computer, cell phone, personal handy-phone system (PHS), personal digital assistant (PDA) or the like, game player, or various information home electronics or the like.

As shown in FIG. 9, the information processing apparatus mainly includes a CPU (Central Processing Unit) 902, a ROM (Read Only Memory) 904, a RAM (Random Access Memory) 906, a Host bus 908, a bridge 910, an external bus 912, an interface 914, an input unit 916, an output unit 918, a storage unit 920, a drive 922, a connection port 924, and a communication unit 926.

The CPU 902 functions as an arithmetic processing unit or a control unit and controls an entire operation of the constituent elements or some of the constituent elements based on various programs recorded on the ROM 904, the RAM 906, the storage unit 920, or the removal recording medium 928. The ROM 904 stores, for example, a program loaded on the CPU 902 or data or the like used in an arithmetic operation. The RAM 906 temporarily or perpetually stores, for example, a program loaded on the CPU 902 or various parameters or the like arbitrarily changed in execution of the program. These constituent elements, are connected to each other by, for example, the host bus 908 which can perform high-speed data transmission. The host bus 908, for example, is connected to the external bus 912 in which a data transmission speed is relatively low through the bridge 910.

The input unit 916 is, for example, an operation unit such as a mouse, a keyboard, a touch panel, button, a switch, or a lever. The input unit 916 may be a remote control unit (so-called remote) that can transmit a control signal by using an infrared ray or other radio waves. The input unit 916 includes an input control circuit or the like to transmit information input by using the operation unit to the CPU 902 through an input signal.

The output unit 918 is, for example, a display device such as a CRT (Cathode Ray Tube), an LCD (Liquid Crystal Display), a PDP (Plasma Display Panel), or an ELD (Electro-Luminescence Display), an audio output device such as a loudspeaker or headphones, a printer, a mobile phone, or a facsimile that can visually or auditorily notify a user of acquired information.

The storage unit 920 is a device to store various data, and includes, for example, a magnetic storage device such as a hard disk drive (HDD; Hard Disk Drive), a semiconductor storage device, an optical storage device, or a magnetooptical storage device, or the like.

The drive 922 is a device that reads information recorded on the removal recording medium 928 such as a magnetic disk, an optical disk, a magnetooptical disk, or a semiconductor memory or writes information in the removal recording medium 928. The removal recording medium 928 is, for example, a DVD medium, a Blue-ray medium, an HD-DVD medium, a compact flash (CF; compactFlash) (registered trademark), a memorystick, or an SD memory card (Secure Digital memory card), or the like. As a matter of course, the removal recording medium 928 may be, for example, an IC card (Integrated Circuit Card) on which a non-contact IC chip is mounted, an electronic device, or the like.

The connection port 924 is a port such as an USB (Universal Serial Bus) port, an IEEE1394 port, an SCSI (Small Computer System Interface), an RS-232C port, or an optical audio terminal to which the external connection device 930 is connected. The external connection device 930 is, for example, a printer, a mobile music player, a digital camera, a digital video camera, an IC recorder, or the like.

The communication unit 926 is a communication device to be connected to a network 932. For example, a communication card for a wired or wireless LAN (Local Area Network), Bluetooth (registered trademark), or WUSB (Wireless USB), an optical communication router, an ADSL (Asymmetric Digital Subscriber Line) router, various communication modems, or the like is used. The network 932 connected to the communication unit 926 includes a wiredly or wirelessly connected network. For example, the Internet, a home-use LAN, infrared communication, broadcasting, satellite communication, or the like is used.

Finally, the functional configurations of the content distribution system and the content reception terminal according to the present embodiment and the operational effects of the functional configurations will be briefly summarized.

At first, the functional configurations of the content distribution system and the content reception terminal according to the present embodiment can be presented as follows.

The content distribution system according to the present embodiment includes a plurality of content distribution servers, a license server, a portal server and a content reception terminal.

One example of the content distribution server described herein is the content server 102 or the content distribution server 104. Further, one example of the license server is the DRM/CAS server 106. Examples of the portal server and the content reception terminal are the portal server 108 and the content reception terminal 130 previously described, respectively.

The content distribution server distributes scrambled contents and streaming-distributes an encrypted scramble key used for releasing the scrambling. In other words, the content distribution server streaming-distributes the contents subjected to the double encryption processing like the MC license system.

The license server is directed for providing a work key for decoding the encrypted scramble key distributed from the predetermined content distribution server. Of course, the work key is provided to the licensed viewer based on a predetermined purchase processing, contract processing or the like. Further, the portal server provides the address information of the predetermined content distribution server. The portal server serves as a window for causing the viewer to designate contents. In other words, the portal server bridges each content and the content distribution server for distributing the same. One of the methods therefor is to provide address information.

Then, the content reception terminal includes an address information obtaining unit, a content obtaining unit, a scramble key decoding unit and a descramble unit.

The address information obtaining unit is directed for obtaining address information of the predetermined content distribution server from the portal server. The content obtaining unit is directed for referring to the address information obtained by the address information obtaining unit to obtain the contents and the scramble key from the predetermined content distribution server. The scramble key decoding unit is directed for using the work key obtained from the license server to decode the scramble key. Further, the descramble unit uses the scramble key to descramble the contents.

One example of the address information obtaining unit denoted herein is the reproduction control metafile obtaining unit 176. However, the reproduction control metafile obtaining unit 176 obtains a reproduction control metafile and extracts address information contained therein, thereby obtaining the address information of the content distribution server 104. Further, one example of the content obtaining unit denoted herein is the content obtaining unit 180. Further, one example of the scramble key decoding unit is the scramble key decoding unit 182. Furthermore, one example of the descramble unit is the descramble unit 184.

The portal server may be configured to further provide information indicating a reproduction control system of the predetermined content distribution server. The reproduction control system includes double speed reproduction, reproduction stop or the like, for example. In this case, the content reception terminal further includes a reproduction control information obtaining unit which obtains information on the reproduction control system from the portal server. Then, the content reception terminal obtains the contents and the scramble key by the content obtaining unit according to the reproduction control system indicated by the information obtained by the reproduction control information obtaining unit. This configuration can avoid a situation in which contents may not be correctly received due to a different reproduction control system.

One example of the reproduction control information obtaining unit denoted herein is the reproduction control metafile obtaining unit 176. However, the reproduction control metafile obtaining unit 176 obtains a reproduction control metafile and extracts information on the reproduction control system contained therein, thereby obtaining the information on the reproduction control system.

The content distribution system may be configured to further include a content distribution server for distributing only encrypted contents decodable by using a content key. For example, when the content distribution system according to the present embodiment is constructed based on the content distribution system in the VoD license system, the above system configuration may be employed.

The license server is configured to provide the work key or the content key depending on the distribution form of the contents distributed by the predetermined content distribution server. The portal server is configured to further provide information indicating the distribution form of the contents distributed by the predetermined content distribution server. One example of the information indicating the distribution form is content type information or license form information contained in the reproduction control metafile. Typically, since the content distribution form and the license form (or encryption form) are in a correspondence relationship, the information is obtained so that the distribution form of the streaming-distributed contents can be identified.

The content reception terminal is further provided with a distribution form obtaining unit which obtains information indicating a distribution form of contents distributed by the predetermined content distribution server from the portal server, and a content decoding unit which decodes the encrypted contents by using a content key obtained from the license server. Then, when a distribution form indicated by the information obtained by the distribution form obtaining unit is a content key system, the content reception terminal is configured to obtain the encrypted contents by the content obtaining unit and to decode the contents by the content decoding unit.

One example of the distribution form obtaining unit denoted herein is the reproduction control metafile obtaining unit 176. However the reproduction control metafile obtaining unit 176 obtains a reproduction control metafile and extracts content type information or the like contained therein to identify the license form of the contents. As noted above, when the distribution form of the contents is identified, it is possible to identify, for example, whether the contents are encrypted in the VoD license system, in the MC license system or in other license system. In the present embodiment, since the double encryption system which is substantially the same as the MC license system is basic, it is possible to easily identify whether the system is basic or other.

One example of the content decoding unit denoted herein is the descramble unit 184. A basic operation of the descramble unit 184 is to descramble the contents by using the decoded scramble key. However, there has been already described that since the present embodiment can cope with the contents encrypted in the content key system, the descramble unit 184 is configured to decode the contents by using a content key. In this manner, the present embodiment is configured to cope with several license systems or encryption forms so that the technique according to the present embodiment is applied to existing systems to easily enhance the availability of the entire system.

The scramble key decoding unit included in the content reception terminal may be configured to obtain a work key from the license server whenever the contents and the scramble key are obtained by the content obtaining unit. Similarly, the content decoding unit included in the content reception terminal may be configured to obtain a content key from the license server whenever the encrypted contents are obtained by the content obtaining unit. This configuration enables the license management to be realized on a content basis.

The functional configuration of the content reception terminal may be presented as follows.

The content reception terminal includes an address information obtaining unit, a distribution form obtaining unit, a content obtaining unit, a key obtaining unit, a scramble key decoding unit and a content decoding unit.

The address information obtaining unit obtains address information of a content distribution server for streaming-distributing an encrypted scramble key used for descrambling scrambled contents or for releasing the scrambling or a content distribution server for distributing encrypted contents decodable by using a content key.

The distribution form obtaining unit obtains information indicating a distribution form of contents distributed from a content distribution server corresponding to the address information. Then, the content obtaining unit refers to the address information obtained by the address information obtaining unit and obtains the contents and the scramble key or the encrypted contents from the content distribution server corresponding to the address information depending on the distribution form indicated by the information obtained by the distribution form obtaining unit.

The key obtaining unit obtains a work key for decoding the scramble key when the distribution form is a work key system, and obtains the content key when the distribution form is a content key system. The scramble key decoding unit uses the work key to decode the scramble key when the distribution form is a work key system. Then, the content decoding unit uses the scramble key to descramble the contents when the distribution form is a work key system, and uses the content key to decode the encrypted contents when the encryption form is a content key system.

One example of the address information obtaining unit and the distribution form obtaining unit denoted herein is the reproduction control metafile obtaining unit 176. One example of the content obtaining unit is the content obtaining unit 180. Further, the one example of the key obtaining unit is the license obtaining unit 172. One example of the scramble key decoding unit is the scramble key decoding unit 182. Further, one example of the content decoding unit is the descramble unit 184. The processing is switched depending on the distribution form in this manner, thereby corresponding to the distribution form using several license systems. Consequently, even when the distribution form is different for each content, the viewer can view the contents irrespective of the distribution form of the license of each content.

As described above, the technique according to the present embodiment is configured such that a license can be issued and managed in association with the DRM/CAS system for the content providing system through the live streaming distribution which needs to know the source of contents for each viewing. Further, the present embodiment provides a content distribution system capable of determining a distribution form of the content reception terminal and switching a content reception processing.

It should be understood by those skilled in the art that various modifications, combinations, sub-combinations and alterations may occur depending on design and other factors insofar as they are within the scope of the appended claims or the equivalents thereof.

The present application contains subjected matter related to that disclosed in Japanese Priority Patent Application JP 2008-177708 filed in the Japan Patent Office on Jul. 8, 2008, the entire contents of which is hereby incorporated by reference.

What is claimed is:

1. A content distribution system comprising:
a plurality of content distribution servers for distributing scrambled contents and streaming-distributing an encrypted scramble key used for releasing the scrambling;
a license server for providing a work key for decoding the encrypted scramble key distributed from the predetermined content distribution server;
a portal server for providing address information of the predetermined content distribution server; and
a content reception terminal including
an address information obtaining unit which obtains address information of the predetermined content distribution server from the portal server,
a content obtaining unit which refers to the address information obtained by the address information obtaining unit and obtains the contents and the scramble key from the predetermined content distribution server,
a scramble key decoding unit which decodes the scramble key by using the work key obtained from the license server, and
a descramble unit which descrambles the contents by using the scramble key.

2. The content distribution system according to claim 1, wherein the portal server further provides information indicating a reproduction control system of the predetermined content distribution server,
the content reception terminal further includes a reproduction control information obtaining unit which obtains information on the reproduction control system from the portal server, and
the content obtaining unit obtains the contents and the scramble key according to the reproduction control system indicated by the information obtained by the reproduction control information obtaining unit.

3. The content distribution system according to claim 1, further comprising a content distribution server for distributing only encrypted contents decodable by using a content key,
wherein the license server provides the work key or the content key depending on a distribution form of contents distributed by the predetermined content distribution server,
the portal server further provides information indicating a distribution form of contents distributed by the predetermined content distribution server,
the content reception terminal further includes:
a distribution form obtaining unit which obtains information indicating a distribution form of contents distributed by the predetermined content distribution server from the portal server; and
a content decoding unit which decodes the encrypted contents by using the content key obtained from the license server, and
the content obtaining unit obtains the encrypted contents to decode the contents by the content decoding unit when the distribution form indicated by the information obtained by the distribution form obtaining unit is a distribution form using a content key system.

4. The content distribution system according to claim 1, wherein the scramble key decoding unit included in the content reception terminal obtains a work key from the license server when starting to obtain contents using a distribution form in which the content obtaining unit provides contents and a scramble key.

5. The content distribution system according to claim 3, wherein the content decoding unit included in the content reception terminal obtains a content key from the license server when obtaining the encrypted contents by the content obtaining unit.

6. A content reception terminal comprising:
an address information obtaining unit which obtains address information of a content distribution server for streaming-distributing an encrypted scramble key used for descrambling scrambled contents or for releasing the scrambling or a content distribution server for distributing encrypted contents decodable by using a content key;
a distribution form obtaining unit which obtains information indicating a distribution form of contents distributed from a content distribution server corresponding to the address information;
a content obtaining unit which refers to the address information obtained by the address information obtaining unit and obtains the contents and the scramble key, or the encrypted contents from a content distribution server corresponding to the address information depending on the distribution form indicated in the information obtained by the distribution form obtaining unit;
a key obtaining unit which obtains a work key for decoding the scramble key when the distribution form uses a work key system, and obtains the content key when the distribution form uses a content key system;
a scramble key decoding unit which decodes the scramble key by using the work key when the distribution form uses a work key system; and
a content decoding unit which descrambles contents by using the scramble key when the distribution form uses a work key system, and decodes the encrypted contents by using the content key when the distribution form is a content key system.

7. A content distribution method comprising the steps of:
obtaining address information of a predetermined content distribution server for distributing scrambled contents and streaming-distributing an encrypted scramble key used for releasing the scrambling from a portal server;
obtaining a work key for decoding the encrypted scramble key distributed from the predetermined content distribution server from a license server;
referring to the address information obtained in the address obtaining step and obtaining the contents and the scramble key from the predetermined content distribution server;
decoding the scramble key by using the work key obtained in the work key obtaining step; and
descrambling the scrambled contents by using the scramble key decoded in the scramble key decoding step.

8. A processing method performed when viewing streaming contents, comprising the steps of:
obtaining address information of a content distribution server for streaming-distributing an encrypted scramble key used for descrambling scrambled contents or for releasing the scrambling or a content distribution server for distributing only encrypted contents decodable by using a content key;
obtaining information indicating a distribution form of contents distributed from a content distribution server corresponding to the address information;
referring to the address information obtained in the address information obtaining step and obtaining the contents and the scramble key, or the encrypted contents from a content distribution server corresponding to the address information;
obtaining a work key for decoding the scramble key when the distribution form uses a work key system, and obtaining the content key when the distribution form is a content key system;
decoding the scramble key by using the work key when the distribution form uses a work key system; and
descrambling scrambled contents by using the scramble key when the distribution form is a work key system, and decoding the encrypted contents by using the content key when the distribution form is a content key system.
